(19) United States
(12) Patent Application Publication
(10) Pub. No.: US 2023/0023381 A1
(43) Pub. Date: Jan. 26, 2023

(54) Electronic Signage Assembly

(71) Applicant: Connie Hernandez, Perth Amboy, NJ (US)

(72) Inventor: Connie Hernandez, Perth Amboy, NJ (US)

(21) Appl. No.: 17/382,519

(22) Filed: Jul. 22, 2021

(51) Int. Cl. B60Q 1/50; G09F 9/30; G09F 21/04

(52) U.S. Cl. CPC B60Q 1/503; G09F 9/30; G09F 21/048

(57) ABSTRACT

An electronic signage assembly for communicating messages to persons proximate to a vehicle includes a messaging unit and a control unit, which are mountable, respectively, to a first substrate and a second substrate positioned within a passenger compartment of a vehicle. The control unit is accessible to a driver of the vehicle. The messaging unit comprises a receiver and a screen. The screen is visible through a window of the vehicle and is operationally engaged to the receiver. The control unit comprises a transceiver and a selector. The transceiver is in wireless communication with the receiver. The selector permits selection by the driver of a respective preprogrammed message from a plurality of preprogrammed messages. The transceiver is positioned to communicate the respective preprogrammed message to the screen. The screen displays the respective preprogrammed message to persons proximate to the vehicle.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to signage assemblies and more particularly pertains to a new signage assembly for communicating messages to persons proximate to a vehicle. The present invention discloses a signage assembly comprising a messaging unit mountable to a rear window of a vehicle. A message on the sign can be controlled by a driver either by selection of a preprogrammed message using a control unit mounted to a steering wheel of the vehicle or by dictation using an electronic device, such as a cellphone.

### (2) Description of Related Art Including Information Disclosed Under 37 CFR 1.97 and 1.98

The prior art relates to signage assemblies for communicating messages between occupants of vehicles. The prior art comprises displays positionable to be viewable through rear windows of vehicles and on which can be displayed preprogrammed messages. What is lacking in the prior art is a signage assembly comprising a messaging unit mountable to a rear window of a vehicle, wherein a message on the sign can be controlled by a driver either by selection of a preprogrammed message using a control unit mounted to a steering wheel of the vehicle or by dictation using an electronic device, such as a cellphone.

### (h) BRIEF SUMMARY OF THE INVENTION

An embodiment of the disclosure meets the needs presented above by generally comprising a messaging unit and a control unit. The messaging unit is configured to be mountable to a first substrate that is positioned within a passenger compartment of a vehicle. The messaging unit comprises a receiver and a screen. The screen is visible through a window of the vehicle and is operationally engaged to the receiver. The control unit is configured to be mountable to a second substrate that is positioned within the passenger compartment so that the control unit is accessible to a driver of the vehicle. The control unit comprises a transceiver and a selector. The transceiver is in wireless communication with the receiver. The selector is configured to permit selection by the driver of a respective preprogrammed message from a plurality of preprogrammed messages. The transceiver is positioned to communicate the respective preprogrammed message to the screen. The screen is configured to display the respective preprogrammed message to persons proximate to the vehicle.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of an electronic signage assembly according to an embodiment of the disclosure.

FIG. 2 is a front view of an embodiment of the disclosure.

FIG. 3 is a detail view of an embodiment of the disclosure.

FIG. 4 is an in-use view of an embodiment of the disclosure.

FIG. 5 is an in-use view of an embodiment of the disclosure.

FIG. 6 is a block diagram of an embodiment of the disclosure.

### (j) DETAILED DESCRIPTION OF THE INVENTION

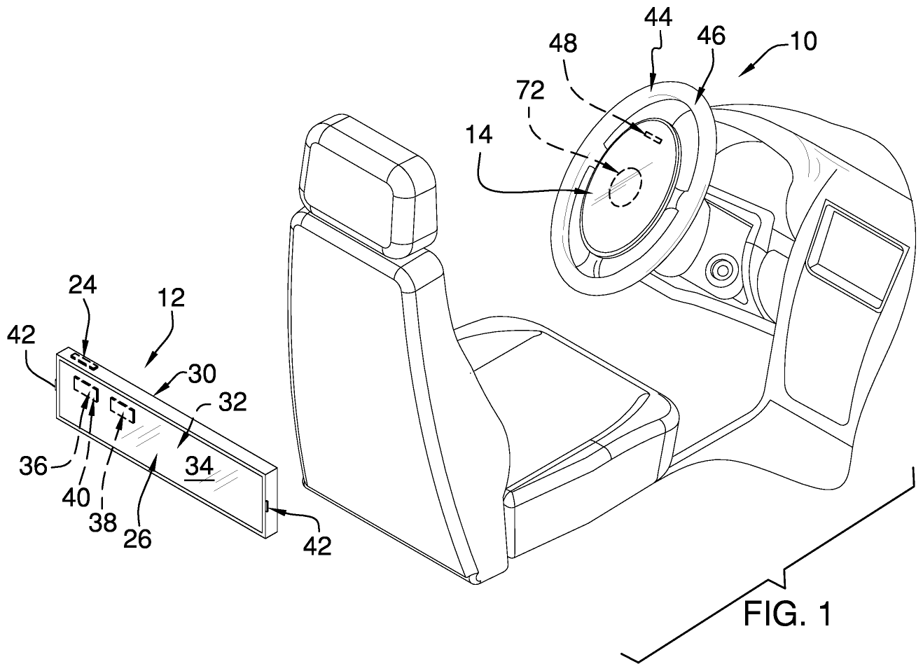

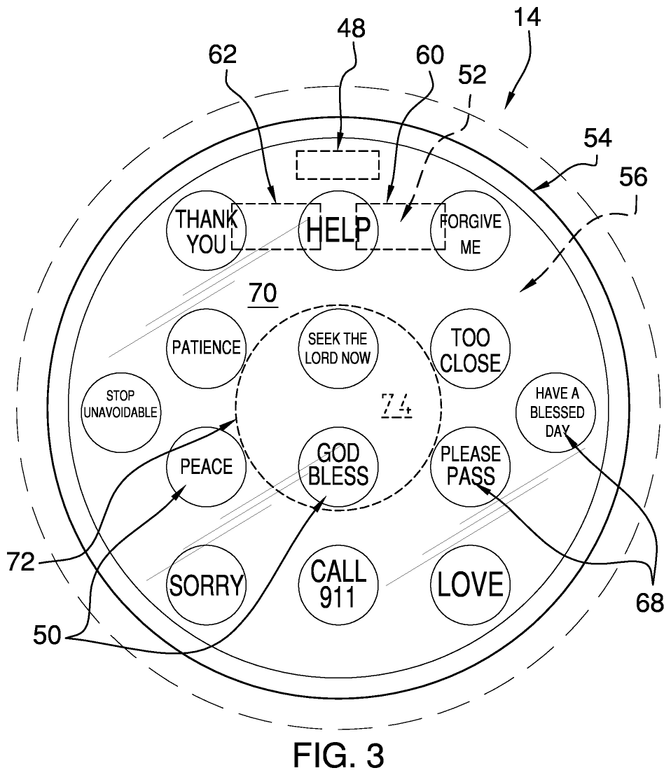

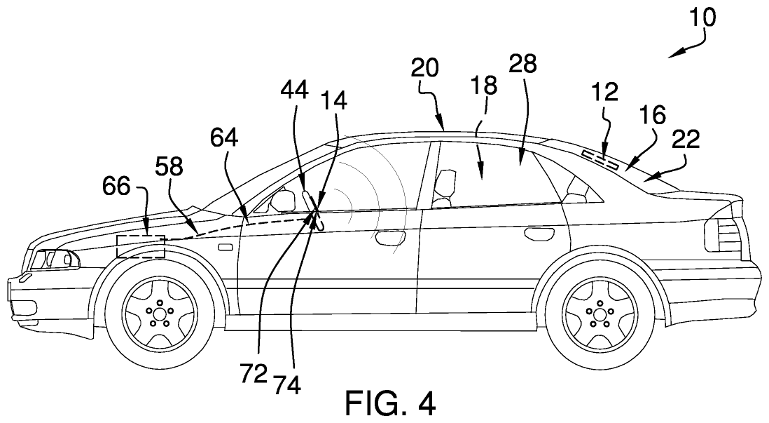

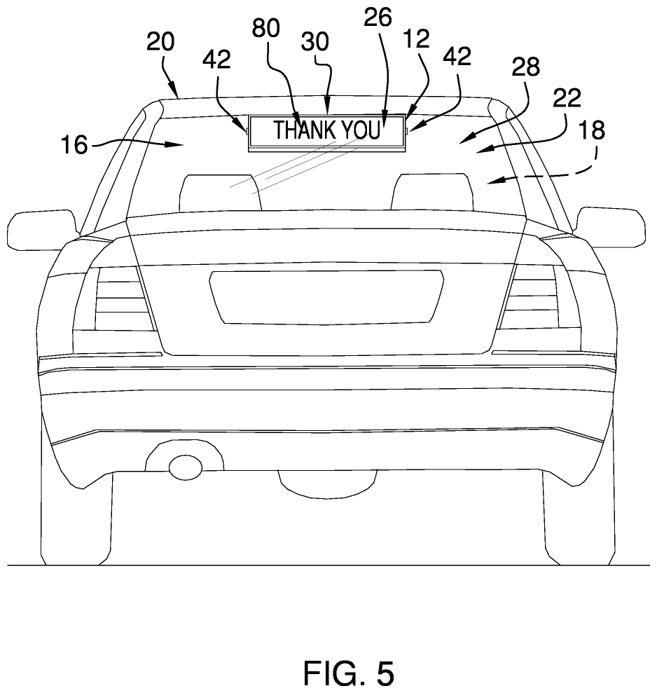

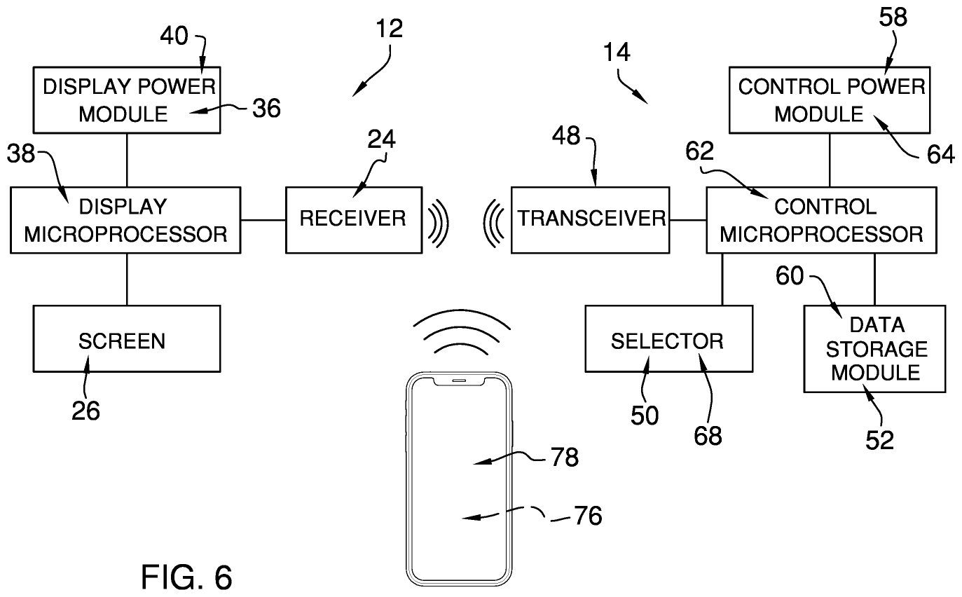

With reference now to the drawings, and in particular to FIGS. 1 through 6 thereof, a new signage assembly embodying the principles and concepts of an embodiment of the disclosure and generally designated by the reference numeral 10 will be described.

As best illustrated in FIGS. 1 through 6, the electronic signage assembly 10 generally comprises a messaging unit 12 and a control unit 14. The messaging unit 12 is configured to be mountable to a first substrate 16 that is positioned within a passenger compartment 18 of a vehicle 20. The messaging unit 12 may be configured to be mountable to a rear window 22 of the vehicle 20. The messaging unit 12 comprises a receiver 24 and a screen 26. The screen 26 is visible through a window 28 of the vehicle 20 and is operationally engaged to the receiver 24.

The messaging unit 12 also comprises a display housing 30, which defines an interior space 32. The receiver 24 is engaged to the display housing 30 and is positioned in the interior space 32. The screen 26 is engaged to a first face 34 of the display housing 30. The display housing 30 may be substantially cuboid shaped, as shown in FIG. 1, although the present invention also anticipates the display housing 30 being alternatively shaped, such as disc shaped, ovally shaped, and the like.

A display power module 36 and a display microprocessor 38 are engaged to the display housing 30 and are positioned in the interior space 32. The display microprocessor 38 is operationally engaged to the receiver 24, the display power module 36, and the screen 26. The display power module 36 comprises a battery 40.

A fastener 42 is engaged to the display housing 30 and is configured to engage the first substrate 16 so that the display housing 30 is mounted to the first substrate 16. The fastener 42 may comprise suction cups, magnets, hook and loop fasteners, and the like.

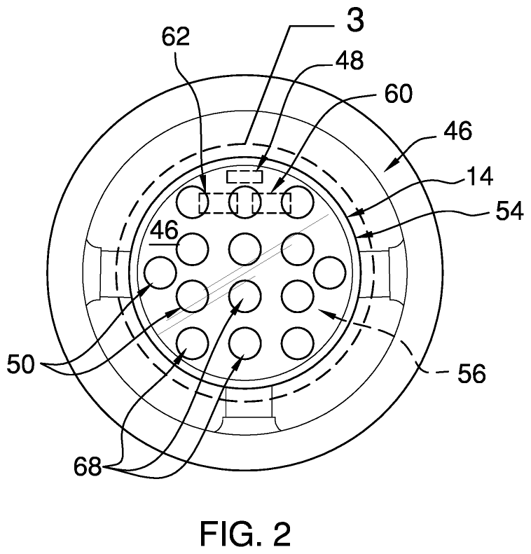

The control unit 14 is configured to be mountable to a second substrate 44 that is positioned within the passenger compartment 18 so that the control unit 14 is accessible to a driver of the vehicle 20. The control unit 14 may be configured to be mountable to a steering wheel 46 of the vehicle 20, as shown in FIG. 2. The control unit 14 comprises a transceiver 48 and a selector 50. The transceiver 48 is in wireless communication with the receiver 24. The selector 50 is configured to permit selection by the driver of a respective preprogrammed message 52 from a plurality of preprogrammed messages 52. The transceiver 48 is positioned to communicate the respective preprogrammed message 52 to the screen 26. The screen 26 is configured to display the respective preprogrammed message 52 to persons proximate to the vehicle 20. The present invention is anticipated to reduce a frequency of road rage incidents by allowing the driver to apologize for or to explain driving behavior that may be irritating to other drivers.

The control unit 14 also comprises a controller housing 54, which defines an internal space 56. The transceiver 48 is engaged to the controller housing 54 and is positioned in the internal space 56. The controller housing 54 may be substantially circularly shaped and substantially concentric with the steering wheel 46, as shown in FIG. 1.

A control power module 58, a data storage module 60, and a control microprocessor 62 are engaged to the controller housing 54 and are positioned in the internal space 56. The control microprocessor 62 is operationally engaged to the selector 50, the transceiver 48, the control power module 58, and the data storage module 60. The control power module 58 may comprise a wired connection 64 to a battery 66 of the vehicle 20, although the present invention also anticipates the control power module 58 comprising a battery (not shown) engaged to the controller housing 54 and positioned in the internal space 56. The plurality of preprogrammed messages 52 is positioned on the data storage module 60.

The selector 50 may comprise a plurality of buttons 68, which is engaged to a first surface 70 of the controller housing 54. The buttons 68 are depressible. Each button 68 is configured to be selectively depressed to signal the control microprocessor 62 to actuate the transceiver 48 to communicate an associated preprogrammed message 52 to the screen 26 via the receiver 24. The selector 50 also may comprise other selection means, such as, but not limited to, touch screens, slide switches, and the like.

A fastening element 72 is engaged to a second surface 74 of the controller housing 54 and is configured to engage the second substrate 44 so that the controller housing 54 is mounted to the second substrate 44. The fastening element 72 may adhesives, hook and loop fasteners, and the like.

The electronic signage assembly 10 also may comprise programming code 76, which is selectively positionable on an electronic device 78 of the driver. The programming code 76 enables the electronic device 78 to translate a dictated message into text 80 and to communicate the text 80 to the control unit 14. The transceiver 48 is positioned to communicate the text 80 to the screen 26 via the receiver 24. The screen 26 is configured to display the text 80 to the persons proximate to the vehicle 20. The present invention also anticipates the text 80 being communicated directly from the electronic device 78 to the messaging unit 12.

In use, the messaging unit 12 and the control unit 14 are mounted to the rear window 22 and steering wheel 46 of the vehicle 20, respectively. When required, the driver can select a respective preprogrammed message 52 from the plurality of preprogrammed messages 52 and have it displayed on the screen 26 for viewing by another driver to a rear of the vehicle 20.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An electronic signage assembly comprising:
a messaging unit configured to be mountable to a first substrate positioned within
a passenger compartment of a vehicle, the messaging unit comprising:
a receiver, and
a screen operationally engaged to the receiver, the screen being visible through a window of the vehicle; and
a control unit configured to be mountable to a second substrate positioned within the passenger compartment, such that the control unit is accessible to a driver of the vehicle, the control unit comprising:
a transceiver in wireless communication with the receiver, and
a selector configured for permitting selection by the driver of a respective preprogrammed message from a plurality of preprogrammed messages, positioning the transceiver for communicating the respective preprogrammed message to the screen, wherein the screen is configured for displaying the respective preprogrammed message to persons proximate to the vehicle.

2. The electronic signage assembly of claim 1, wherein the messaging unit is configured to be mountable to a rear window of the vehicle.

3. The electronic signage assembly of claim 1, wherein the messaging unit comprises:
a display housing defining an interior space, the receiver being engaged to the display housing and positioned in the interior space, the screen being engaged to a first face of the display housing;
a display power module engaged to the display housing and positioned in the interior space; and
a display microprocessor engaged to the display housing and positioned in the interior space, the display microprocessor being operationally engaged to the receiver, the display power module, and the screen.

4. The electronic signage assembly of claim 3, wherein the display housing is substantially cuboid shaped.

5. The electronic signage assembly of claim 3, wherein the display power module comprises a battery.

6. The electronic signage assembly of claim 3, further including a fastener engaged to the display housing and being configured for engaging the first substrate, such that the display housing is mounted to the first substrate.

7. The electronic signage assembly of claim 1, wherein the control unit comprises:
a controller housing defining an internal space, the transceiver being engaged to the controller housing and positioned in the internal space;
a control power module engaged to the controller housing and positioned in the internal space;
a data storage module engaged to the controller housing and positioned in the internal space, the plurality of preprogrammed messages being positioned on the data storage module;
a control microprocessor engaged to the controller housing and positioned in the internal space, the control microprocessor being operationally engaged to the selector, the transceiver, the control power module, and the data storage module; and
the selector comprising a plurality of buttons engaged to a first surface of the controller housing, the buttons being depressible, wherein each button is configured for being selectively depressed for signaling the control microprocessor for actuating the transceiver for communicating an associated preprogrammed message to the screen via the receiver.

8. The electronic signage assembly of claim 7, wherein the control unit is configured to be mountable to a steering wheel of the vehicle.

9. The electronic signage assembly of claim 8, wherein the controller housing is substantially circularly shaped and substantially concentric with the steering wheel.

10. The electronic signage assembly of claim 7, wherein the control power module comprises a wired connection to a battery of the vehicle.

11. The electronic signage assembly of claim 7, further including a fastening element engaged to a second surface of the controller housing and being configured for engaging the second substrate, such that the controller housing is mounted to the second substrate.

12. The electronic signage assembly of claim 1, further including programming code selectively positionable on an electronic device of the driver, the programming code enabling the electronic device for translating a dictated message into text and for communicating the text to the control unit, positioning the transceiver for communicating the text to the screen via the receiver, wherein the screen is configured for displaying the text to the persons proximate to the vehicle.

13. An electronic signage system comprising:
a vehicle;
a messaging unit mounted to a first substrate positioned within a passenger compartment of the vehicle, the messaging unit comprising:
a receiver, and
a screen operationally engaged to the receiver, the screen being visible through a window of the vehicle; and
a control unit mounted to a second substrate positioned within the passenger compartment, such that the control unit is accessible to a driver of the vehicle, the control unit comprising:
a transceiver in wireless communication with the receiver, and
a selector configured for permitting selection by the driver of a respective preprogrammed message from a plurality of preprogrammed messages, positioning the transceiver for communicating the respective preprogrammed message to the screen, wherein the screen is configured for displaying the respective preprogrammed message to persons proximate to the vehicle.

14. An electronic signage assembly comprising:
a messaging unit configured to be mountable to a first substrate positioned within a passenger compartment of a vehicle, the messaging unit being configured to be mountable to a rear window of the vehicle, the messaging unit comprising:
a receiver,
a screen operationally engaged to the receiver, the screen being visible through a window of the vehicle,
a display housing defining an interior space, the receiver being engaged to the display housing and positioned in the interior space, the screen being engaged to a first face of the display housing, the display housing being substantially cuboid shaped,
a display power module engaged to the display housing and positioned in the interior space, the display power module comprising a battery;
a display microprocessor engaged to the display housing and positioned in the interior space, the display microprocessor being operationally engaged to the receiver, the display power module, and the screen, and
a fastener engaged to the display housing and being configured for engaging the first substrate, such that the display housing is mounted to the first substrate;
a control unit configured to be mountable to a second substrate positioned within the passenger compartment, such that the control unit is accessible to a driver of the vehicle, the control unit being configured to be mountable to a steering wheel of the vehicle, the control unit comprising:
a transceiver in wireless communication with the receiver,
a selector configured for permitting selection by the driver of a respective preprogrammed message from a plurality of preprogrammed messages, positioning the transceiver for communicating the respective preprogrammed message to the screen, wherein the screen is configured for displaying the respective preprogrammed message to persons proximate to the vehicle,
a controller housing defining an internal space, the transceiver being engaged to the controller housing and positioned in the internal space, the controller housing being substantially circularly shaped and substantially concentric with the steering wheel,
a control power module engaged to the controller housing and positioned in the internal space, the control power module comprising a wired connection to a battery of the vehicle,
a data storage module engaged to the controller housing and positioned in the internal space, the plurality of preprogrammed messages being positioned on the data storage module,
a control microprocessor engaged to the controller housing and positioned in the internal space, the control microprocessor being operationally engaged to the selector, the transceiver, the control power module, and the data storage module,
the selector comprising a plurality of buttons engaged to a first surface of the controller housing, the buttons being depressible, wherein each button is configured for being selectively depressed for signaling the control microprocessor for actuating the transceiver for communicating an associated preprogrammed message to the screen via the receiver, and
a fastening element engaged to a second surface of the controller housing and being configured for engaging the second substrate, such that the controller housing is mounted to the second substrate; and
programming code selectively positionable on an electronic device of the driver, the programming code enabling the electronic device for translating a dictated message into text and for communicating the text to the control unit, positioning the transceiver for communicating the text to the screen via the receiver, wherein the screen is configured for displaying the text to the persons proximate to the vehicle.
